(19) United States
(12) Patent Application Publication
(10) Pub. No.: US 2024/0119500 A1
(43) Pub. Date: Apr. 11, 2024

(54) Optimization of Product Presentation

(71) Applicant: Grabango Co., Berkeley, CA (US)

(72) Inventor: William Glaser, Berkeley, CA (US)

(21) Appl. No.: 18/236,432

(22) Filed: Aug. 22, 2023

Related U.S. Application Data
(63) Continuation of application No. 17/484,724, filed on Sep. 24, 2021, now abandoned.
(60) Provisional application No. 63/082,936, filed on Sep. 24, 2020.

(51) Int. Cl. G06Q 30/0601; G06N 3/08

(52) U.S. Cl. CPC G06Q 30/0623; G06N 3/08

(57) ABSTRACT

Systems and methods for automated management of product presentation using remote sensing systems that can include collecting image data and generating a presentation characterization of detected products. The systems and methods can additionally include variations including detecting interaction data and training a presentation classification model using the interaction data and image data. The systems and methods can additionally include updating state of one or more computing device based on the presentation characterization.

### CROSS-REFERENCE TO RELATED APPLICATIONS

This application is a Continuation application of U.S. patent application Ser. No. 17/484,724, filed on 24 Sep. 2021, which claims the benefit of U.S. Provisional Application No. 63/082,936, filed on 24 Sep. 2020, both of which are incorporated in their entirety by this reference.

### TECHNICAL FIELD

This invention relates generally to the field of inventory management systems, and more specifically to a new and useful system and method for automated product presentation management.

### BACKGROUND

Managing inventory in a retail environment is incredibly complex. In many stores, there can be tens or even hundreds of thousands of products on the shelves at any one time. In most stores, there is a significant amount of worker time that is devoted to resetting the presentation of these products because the products constantly get moved resulting from customer interactions and other activities. While it is generally understood that a well-organized store can better sell products, stores often are left to basic human-level operational practices to improve product presentation. This usually means infrequent full store resets which typically happen while a store is closed.

There are few technical tools to assist with this problem. Complicating the issue is that many stores, such as grocery stores, handle a wide diversity of products and ways of displaying products. Some stores may have tens or hundreds of thousands of different product SKUs. Such complicating factors has limited prior technologies to assist with even routine, basic monitoring across a store environment.

Thus, there is a need in the inventory management system field to create a new and useful system and method for automated product presentation management. This invention provides such a new and useful system and method.

### BRIEF DESCRIPTION OF THE FIGURES

FIG. 1 is a schematic representation of a system.

FIG. 2 is a schematic representation of a presentation classification model using image data.

FIG. 3 is a schematic representation of a presentation classification model using image data and presentation properties extracted from the image data.

FIG. 4 is a schematic representation of detecting packaging variations.

FIGS. 5-11 are flowchart representations of variations of the method.

FIG. 12 is a schematic representation of a method variation using transaction interaction data in training a classification model.

FIG. 13 is a schematic representation of a method variation using user-product interaction data in training a classification model.

FIG. 14 is a diagram representation of dynamically communicating a stocking task to a worker mobile device.

FIG. 15 is a diagram representation of dynamically directing a robotic stocking device.

FIG. 16 is an exemplary system architecture that may be used in implementing the system and/or method.

### DESCRIPTION OF THE EMBODIMENTS

The following description of the embodiments of the invention is not intended to limit the invention to these embodiments but rather to enable a person skilled in the art to make and use this invention.

### 1. Overview

A system and method for automated management of product presentation uses computer vision driven analysis and integration with operation-based computing systems to improve monitoring and maintaining of product presentation.

The systems and methods can make use of real-time detection and tracking of products to generate a presentation score (e.g., a “tidiness score” or other form of presentation characterization). The systems and methods can automatically correlate this presentation score with actual customer-product interactions.

The systems and methods may be used in a variety of ways within the retail environment.

As one exemplary application, the systems and methods can be used in monitoring the presentation of products within a retail environment. Furthermore, this may be used to understand presentation of products across multiple retail environments. The systems and methods can enable such monitoring and automated tracking with real-time accuracy or frequent updates (e.g., per-minute, hour, day updates) In some examples, computer vision may be able to characterize presentation of products. The systems and methods described herein can be used to detect and characterize the nature of presentation of individual types of products. The systems and method described herein may additionally detect and characterize ambient presentation factors such as placement and arrangement within the store environment (e.g., shelf and aisle placement, and how it's “faced” or stacked), adjacent items, adjacent or proximal marketing material, and/or other factors.

Furthermore, in some variations, presentation of products may be directly mapped to interactions and actions taken on those products. For example, the system can be used to directly map the real-time presentation of a product when a purchase happened. Similarly, the change in product presentation can be tracked for different interactions.

Mapping or correlating tracked user interactions with presentation may be further used to systematically determining or optimizing for presentation configuration based on desired interaction outcomes. In this way, the systems and methods could automatically learn to classify or detect presentations of products that are predicted to have different results. This variation could provide flexibility for store operators to experiment with new presentations without being restricted to a set of limited options. Alternatively, analysis of the product performance can incorporate presentation characterization and various interaction data into a report.

Such an automated system may further enable the systems and methods to be used with a digital management platform where store operators, product manufacturers, or other entities may set configuration that can then be applied for automating direction of product stocking operations. For example, a new cereal product may select presentation configuration to optimize for user viewing while another cereal could select presentation configuration for end sales.

As another exemplary application, the systems and methods may be used in directing or augmenting operational systems used within the retail environment. The systems and methods may be used with a worker management and communication system so as to intelligently direct workers to alter product presentation. For example, specific products or regions of the store can be detected as needing presentation adjustments (e.g., aligning facing of products, reorganization, and/or tidying). These identified regions may be prioritized based on a measure of their current presentation, sales impact, worker position, customer proximity/activity, and/or other factors.

As another exemplary application, the systems and methods can be used in specifying planogram plans for how stocking of products on shelves should be organized. Different products may benefit from different types of facing. As one example, one product may benefit from a first style of presentation (e.g., front facing, side facing, stacked, etc.), while a second benefits from a second style. This understanding of prioritized presentation styles can come from collecting sales data (or other forms of interaction data) and merging it with automated sensing of presentation of products. In another example, the presentation of a product (and possibly its patterns of change in presentation score) can be used to determine product shelf placement arrangement to improve sales performance and/or improve shelving state of the products. This may reduce negative effects to products and neighboring products. For example, some products may tend to have shelf tidiness more rapidly degrade, some products may be less impacted by their presentation or nearby product presentation, and other products may be more negatively impacted by presentation.

In another variation, individual purchase decisions can be tied to impact to presentation of one or more products. For example, automated sensing of the environment may be used to track the individual products with which a customer interacts and then measure the change in presentation because of those interactions. These customer-product interactions may be further tied to purchase decisions (e.g., purchased product or did not purchase). Automated sensing and analysis of the impact of presentation can be used to enable a system that provides improved automation for managing product inventory.

The systems and methods may have particular applicability to automated stocking systems. Automated stocking systems can use mobile robotic systems or other item manipulation systems used to move and manipulate products. For example, a mobile robotic system may move through a retail environment and stock shelves as well as rearrange products on shelves or otherwise displayed. The systems and methods when used in connection with these systems can better make use of such limited stocking systems. For example, the systems and methods can be used to track the state of degradation of product tidiness and predict changes in tidiness within a retail environment, track and predict customer interactions and location, and/or coordinate communication of instructions to an automated stocking system to improve presentation of products while minimizing disruption to the retail environment.

The systems and methods can have applications in a wide variety of environments. In one variation, the systems and methods can be used within an open environment such as a shopping area or sales floor where products are displayed for user purchase or other forms of user interaction. Shoppers may interact with products in a variety of manners, which may involve product inspection, product pickups, product put-backs (i.e., putting back on a shelf) adding items to carts or bags, product purchases, and/or other interactions. For example, the system and method can be used within a store such as a grocery store, big box store, bookstore, convenience store, drugstore, shoe store, apparel/clothing store, and/or any suitable type of shopping environment.

Herein, the systems and methods are primarily described using examples from grocery store environments, but the systems and methods are not limited to only those retail environments. Additionally, herein reference to product may be understood to refer to any suitable type of object or item that may be subject to tracking and managing of presentation.

In a grocery store environment, the systems and methods may be used to detect and manage how products are presented when stored/displayed on shelves, bins, refrigerators, and/or other storage items. Outputs of the systems and methods can communicate measurements or other characterizations of presentation for many products (e.g., all or a subset) in the store. These presentation characterizations may be customized and calibrated based on the product identity, type, or other factors.

As an example of the systems and methods used in an alternative retail environment, the systems and methods could be used in a clothing store. The organization and presentation of clothing as well as color variations, pattern variations, fit variations, sizing variations, and/or other product variations could be detected and tracked. Additionally, if and how clothing is presented on mannequins, display racks, and shelves could be detected and automatically tracked. These product presentation factors could be mapped to user interactions to understand what items result in purchase, to try-ons with purchase, try-ons without purchases, sizing/color decisions, and/or other interactions specific to a clothing store.

The systems and methods may provide a number of potential benefits. The systems and methods are not limited to always providing such benefits and are presented only as exemplary representations for how the systems and methods may be put to use. The list of benefits is not intended to be exhaustive and other benefits may additionally or alternatively exist.

The systems and methods as one potential benefit can enable visibility into the state of products within a retail environment. This sensing of the presentation of products can be updated in substantially real-time. In some variations of the systems and methods, learned presentation classification models can be used in continually or periodically monitoring the state of a store so that undesired changes can be alerted on and resolved. In some instances, such monitoring may be based on detecting changes in stocking or other changes.

The systems and methods can further associate the presentation with actual events. For example, the presentation may be associated with user interactions at the shelving location of the product and also in the overall purchase decision for the product. This may be used in assigning value and priority to presentation state. For example, products more sensitive to having ideal presentation may be signaled to have higher priority compared to a product detected to be less impacted by having less than ideal presentation. This in turn can be used in automating operational actions.

The systems and methods as another potential benefit may automatically learn to detect or classify presentation of products. Some variations of the systems and methods may enable automatic generation of interaction data that labels image data and/or detected product presentation parameters with interaction results. A resulting classification learning model (e.g., a deep learning neural network) can then be used in predicting interaction results given a set of image data and/or detected product presentation parameters.

The systems and methods as another potential benefit can improve the operations of the store. Workers can be intelligently deployed to modify product presentation when it deviates from a desired state.

The systems and methods may additionally provide potential benefits to tracking and responding to other presentation related factors. This can include tracking and managing presentation of products relative to or in combination with adjacent or related products. This may additionally or alternatively include tracking and managing visual marketing used to promote a product or related product. For example, the impact of a promotional coupon or discount displayed in proximity to a product may impact the “presentation” of a product and its predicted interactions. Related presentation factors may additionally or alternatively include tracking and managing product packaging. For example, the impact of different packaging variations could be detected and tracked.

### 2. System

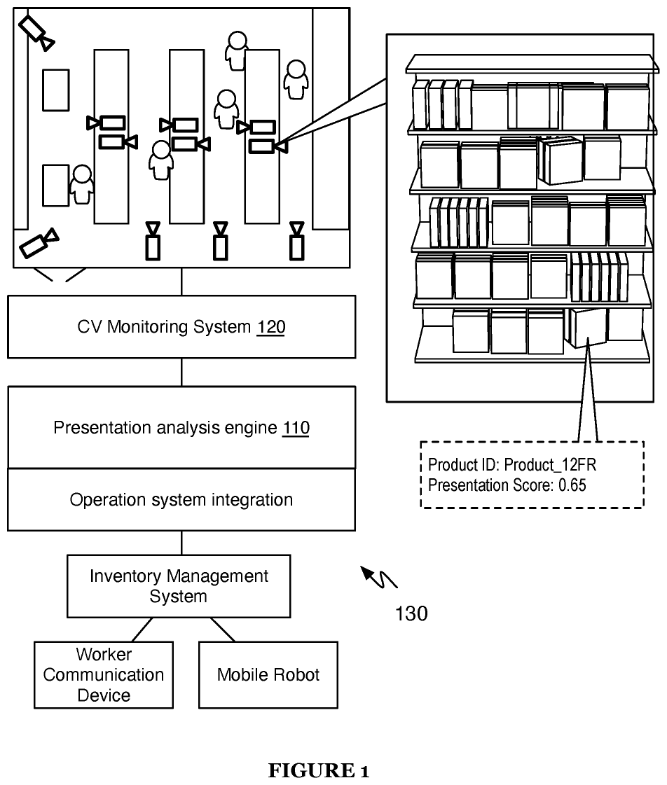

As shown in FIG. 1, a system for automated management of product presentation preferably includes a presentation analysis engine 110 that is integrated with a CV monitoring system 120. The system may additionally include an operation system integration 130.

The presentation analysis engine 110 functions to process and transform image data of the retail environment to determine a data representation characterizing the presentation of detected products. The presentation analysis engine 110 can use various machine learning, AI models, Deep learning models, and/or other image analysis processes to assign one or more different presentation properties. As discussed herein, the nature of the presentation characterization can vary depending on implementation.

The presentation analysis engine 110 preferably outputs a presentation characterization for a set of products (or other types of items) within the environment. In some variations, the presentation analysis engine 110 generates a presentation characterization of each visible product for purchase within a region of the environment or within a whole retail environment. Presentation characterizations are preferably associated with specific product identifiers (e.g., identified by SKU, product identifier, or other type of identifier). In alternative variations, a presentation characterization may alternatively be partially or full independent of a product identifier. For example, a presentation characterization may be generated for regions of the environment.

The presentation characterization may be formed in a machine interpretable format. In one variation, the presentation characterization can be or include a score using one or more numerical dimension to measure the state of presentation. As an example, a presentation score (i.e., presentation characterization score) could range between 0 to 100 with 100 corresponding to the product being in an ideal presentation state and 0 indicating the product having the product displayed in or below an unsatisfactory state. In another variation, a presentation score may include a set of presentation metrics with different numerical measurements. For example, one exemplary presentation score could include a facing score ranging 0 to 1 to indicate how well aligned the front face of the product is with a display structure and an arrangement score ranging from 0 to 1 to indicate how well a collection of the product items are stacked or arranged (0 to indicate non-uniform arrangement and 1 to indicate regular arrangement).

In another variation, the presentation characterization can be or include a classification. A presentation classification (i.e., a presentation characterization classification) can map the state of presentation to one of a set of different states. In one example, a presentation classification could categorize a product into one of “unacceptable”, “acceptable”, and/or “exceptional” presentation states. Classifications may additionally or alternatively serve more as tags or labels so that a product could have one or a set of labels related to its presentation based on the conditions.

In another related variation, the presentation characterization may assign descriptors. Presentation descriptors (presentation characterization descriptors) may include or be part of the presentation classifications. the descriptors may call out properties relating different properties of the presentation. For example, presentation descriptors for one product could include “front facing”, “3-columns”, “shelf 3”, “product X packaging variation 20200901”. Other exemplary presentation descriptor labels could call out typical issues or states such as “non-uniform arrangement”, “unaligned facing”, “irregular stacking”, “uniform presentation”, “nearby product marketing/promotion”, and/or other states.

In one variation, the system, and more specifically the presentation analysis engine 110, can include a presentation descriptor model, which functions as a captioning model to output descriptors of the product presentation. The presentation descriptor model can be a trained computer vision classification model (e.g., a neural network). The model can be trained on a dataset of product images with descriptors of the product's presentation. In some variations, the system automatically learns presentations with good or poor performance. The presentation descriptor model can be used to automate generation of human interpretable descriptions of different presentation states. These may include details such as describing state of tidiness of product displays, arrangement of product displays, inventory levels of products, placement/arrangement within an environment, placement/arrangement in relation to other products, packaging variations, and the like.

In one variation, the presentation analysis engine 110 includes a presentation classification model, which functions as a learning model (e.g., a deep neural network) trained to output a presentation characterization or classification given a set of input features. The system may alternatively use an alternative processing pipeline or module which can use one or a variety of configured data modeling processes in transforming input data to a result providing some presentation characterization.

In one variation, the presentation classification model may be a trained learning model that is trained with data labeled with descriptive states of the presentation. In this way, an image could be classified as various descriptive states.

In another variation, the presentation classification model may be a trained learning model that is trained with data labeled with associated interaction events. This variation functions to correlate the state of presentation with different interaction events of interest. As an example, item purchase events can be mapped to the presentation of products during (or temporally preceding) purchase events of that type of product or specific product.

In some variations, multiple presentation classification models can be trained and used to provide multiple forms of presentation classification.

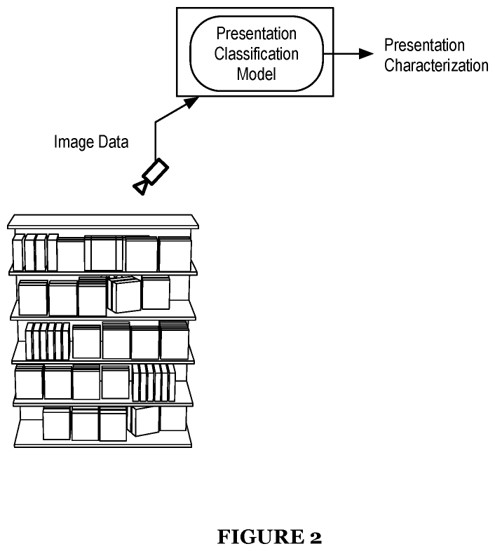

As shown in FIG. 2, one variation of the presentation classification model uses image-based feature inputs, which functions to use image data of a product to output a presentation characterization/classification.

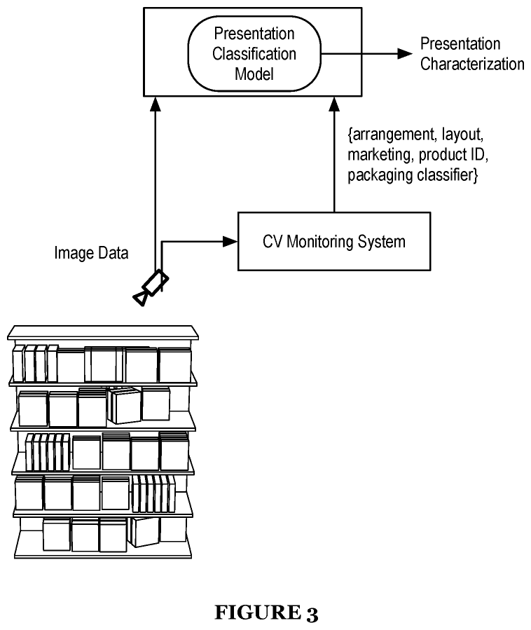

As shown in FIG. 3, in one variation a set of extracted features may be supplied as additional or alternative inputs to a presentation classification model. This could be done in addition to or as an alternative to image data input features supplied to the presentation classification model. The extracted presentation features may be generated or output from additional processing modules. Examples of additional processing modules can include a product arrangement module, a product layout module, marketing detection module, product identity module, and/or product packaging classifier.

A product arrangement module functions to classify or characterize product arrangement such as how an individual product is stacked, arranged, or otherwise organized. For a product on a shelf this may include how the product is stacked, how many spots on the shelf are being used, and/or other details. Visual classification models, product segmentation, and/or other processes can be used.

A product layout module functions to determine properties related to adjacent products. In one variation, the product layout may indicate the identity or descriptors of directly adjacent products. In another variation, a product layout module could characterize a full or partial planogram or map of product layout across a region of the environment. In some variations, a planogram or other suitable type of product-map may be generated and/or provided by another source. Product layout may, in some variations, be used to classify presentation based, at least in part, on display location of a product. For example, a presentation classification model could be trained to predict purchase events based on where in a store a particular product is stocked.

A marketing detection module functions to detect instances of marketing material or promotions in proximity to a product. The marketing detection module may detect in collected image data if an advertisement, a promotion, sign, or other form of marketing collateral was in proximity to the item. The marketing detection module may additionally detect if and which marketing materials are associated with a particular product (e.g., a promotion for the specific product or brand of the product) or for a different product.

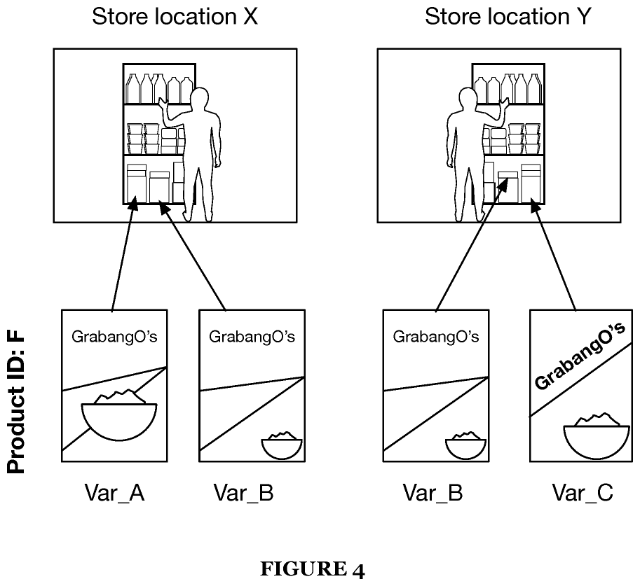

A product packaging classifier functions to assign an identifier, classifier, or other indicator that relates to visual appearance of the product. The product packaging classifier can be used to detect and track different visual packaging differences of a product. As shown in FIG. 4, packaging variations can be detected and assigned a packaging identifier such that other instances with the same packaging can be similarly labeled. Such packaging variations may work across multiple environments. This may be used so that the impact of a particular product can be tracked and used in assessing impact of its presentation.

Product identity could be determined by the CV monitoring system 120 but may alternatively be determined by the presentation analysis engine 110. Product identity may alternatively be determined or communicated from a planogram data model, a product map data model, and/or from an external system.

The operation system integration 130 functions as a system integration with one or more computer-implemented retail operational service. In some variations, the system may include the operation system integration 130. In other variations, the system includes a communication integration for receiving and/or transmitting data and/or instructions between the system and the operation system. For example, the system may communicatively integrate with an external operation system like a POS (Point of Sale) system of the store.

The operation system integration 130 in one variation can include a checkout system or an integration with one or more checkout systems. This functions to provide purchase related interaction event data. In particular the operation system integration 130 with a checkout system provides transaction related interaction event data. The transaction data may be used as input the presentation analysis engine 110. For example, transaction data may be used in training and updating a presentation classification model. Purchase data can be obtained from a POS or other suitable checkout system.

In one variation, the CV system may facilitate one or more types of automated checkout (e.g., checkout-free shopping) wherein a virtual cart is generated based on sensed activity of customers. in this case, the checkout system may be or include the CV monitoring system 120.

In addition to or as an alternative to CV-facilitated checkout, the CV monitoring system 120 may provide additional or alternative interaction event data. For example, the CV monitoring system 120 may output interaction event data related to user-product interactions like product inspection (e.g., detected directed attention of a user at or in region of product), product pickups, product put-backs, adding product to basket, product purchases, and/or other interactions.

In another variation, the operation system integration 130 can include an integration with a stocking or worker management platform. This management platform preferably tracks product stocking and/or manages worker tasks. This integration can be used in selectively assigning tasks and/or sending communications for resolving presentation issues. A stocking management platform can be updated with stocking tasks, plans, or reports based on the presentation characterizations. For example, a prioritized list of tasks may be generated and presented in the stocking management system to indicate which products/regions are detected as needing adjustment to product presentation. in another implementation, updated planograms or stocking plans could be generated and updated within the stocking management system.

In a related variation, the operation system integration 130 may include a worker communication device (or set of devices) through which tracking information indicating tasks and/or location can be obtained. Additionally, the worker communication device can be used as an endpoint for receiving communicated tasks generated by the system.

In another variation, the operation system integration 130 may include or be integrated with one or more automated stocking devices. The automated stocking devices could include robotic stocking devices that can move through the environment and perform one or more type of stocking activity. Robotic stocking devices could be controlled based on state of presentation characterizations throughout the store such that the presentation of items can be maintained in an automated fashion.

The system preferably includes some form of a monitoring system functions to track and monitor products, and optionally, people in the environment. More specifically, the monitoring system tracks the displayed products, their identity, and presentation. The monitoring system may additionally monitor and track various events such as user-product interactions like picking up a product or looking at a product. The monitoring system may include one or a combination of sensing/monitoring systems. The monitoring system may include a CV monitoring system 120, a smart shelving system, an RFID tag tracking system, and/or other suitable types of monitoring systems. Herein, the system is primarily described as using a CV monitoring system 120 despite variations of the system may use other types of monitoring systems.

A CV monitoring system 120 of a preferred embodiment functions to transform image data collected within the environment into observations relating in some way to products in the environment. Preferably, the CV monitoring system 120 is used for detecting products, characterizing shelf/display presentation, monitoring users, tracking user-product interactions, and/or making other conclusions based on image and/or sensor data. The CV monitoring system 120 will preferably include various computing elements used in processing image data collected by an imaging system. In particular, the CV monitoring system 120 will preferably include an imaging system and a set of modeling processes and/or other processes to facilitate analysis of user actions, product state, and/or other properties of the environment.

The CV monitoring system 120 is preferably configured to facilitate identifying of products, the locations of products relative to various shelf-space locations, and/or detection of interactions associated with identified products.

The CV monitoring system 120 preferably provides specific functionality that may be varied and customized for a variety of applications. In addition to product identification, the CV monitoring system 120 may additionally facilitate operations related to person identification, virtual cart generation, product interaction tracking, store mapping, and/or other CV-based observations. Preferably, the CV monitoring system 120 can at least partially provide: person detection; person identification; person tracking; object detection; object classification; object tracking; gesture, event, or interaction detection; detection of a set of customer-product interactions, and/or other forms of information.

In one preferred embodiment, the system can use a CV monitoring system 120 and processing system such as the one described in the published US Patent Application 2017/0323376 filed on May 9, 2017, which is hereby incorporated in its entirety by this reference. The CV monitoring system 120 will preferably include various computing elements used in processing image data collected by an imaging system.

The imaging system functions to collect image data within the environment. The imaging system preferably includes a set of image capture devices. The imaging system might collect some combination of visual, infrared, depth-based, lidar, radar, sonar, and/or other types of image data. The imaging system is preferably positioned at a range of distinct vantage points. However, in one variation, the imaging system may include only a single image capture device. In one example, a small environment may only require a single camera to monitor a shelf of purchasable products. The image data is preferably video but can alternatively be a set of periodic static images. In one implementation, the imaging system may collect image data from existing surveillance or video systems. The image capture devices may be permanently situated in fixed locations. Alternatively, some or all may be moved, panned, zoomed, or carried throughout the facility in order to acquire more varied perspective views. In one variation, a subset of imaging devices can be mobile cameras (e.g., wearable cameras or cameras of personal computing devices). For example, in one implementation, the system could operate partially or entirely using personal imaging devices worn by users in the environment (e.g., workers or customers).

The imaging system preferably includes a set of static image devices mounted with an aerial view from the ceiling or overhead. The aerial view imaging devices preferably provide image data that observes at least the users in locations where they would interact with products. Preferably, the image data includes images of the products and users (e.g., customers or workers). While the system (and method) is described herein as it would be used to perform CV as it relates to a particular product and/or user, the systems and methods can preferably perform such functionality in parallel across multiple users and multiple locations in the environment. Therefore, the image data may collect image data that captures multiple products with simultaneous overlapping events. The imaging system is preferably installed such that the image data covers the area of interest within the environment.

Herein, ubiquitous monitoring (or more specifically ubiquitous video monitoring) characterizes pervasive sensor monitoring across regions of interest in an environment. Ubiquitous monitoring will generally have a large coverage area that is preferably substantially continuous across the monitored portion of the environment. However, discontinuities of a region may be supported. Additionally, monitoring may monitor with a substantially uniform data resolution or at least with a resolution above a set threshold. In some variations, a CV monitoring system 120 may have an imaging system with only partial coverage within the environment.

A CV-based processing engine and data pipeline preferably manages the collected image data and facilitates processing of the image data to establish various conclusions. The various CV-based processing modules are preferably used in generating user-product interaction events, a recorded history of user actions and behavior, and/or collecting other information within the environment. The data processing engine can reside local to the imaging system or capture devices and/or an environment. The data processing engine may alternatively operate remotely in part or whole in a cloud-based computing platform.

The product detection module of a preferred embodiment, functions to detect and apply an identifier to an object. The product detection module preferably performs a combination of object detection, segmentation, classification, and/or identification. This is preferably used in identifying products or products displayed in a store. Preferably, a product can be classified and associated with a product SKU (stock keeping unit) identifier. In some cases, a product may be classified as a general type of product. For example, a carton of milk may be labeled as milk without specifically identifying the SKU of that particular carton of milk. An object tracking module could similarly be used to track products through the store.

In a successfully trained scenario, the product detection module properly identifies a product observed in the image data as being associated with a particular product identifier. In that case, the CV monitoring system 120 and/or other system elements can proceed with normal processing of the product information. In an unsuccessful scenario (i.e., an exception scenario), the product detection module fails to fully identify a product observed in the image data. An exception may be caused by an inability to identify an object but could also be other scenarios such as identifying at least two potential identifiers for a product with sufficiently close accuracy, identifying a product with a confidence below a certain threshold, and/or any suitable condition whereby a remote product labeling task could be beneficial. In this case the relevant image data is preferably marked for labeling and/or transferred a product mapping tool for human assisted identification.

As described below, the product detection module may use information from detected physical labels to assist in the identification of products.

The product detection module in some variations may be integrated into a product inventory system. The product inventory system functions to detect or establish the location of inventory/products in the environment. The product inventory system can manage data relating to higher level inventory states within the environment. For example, the inventory system can manage a location/position product map, which could be in the form of a planogram. The planogram may be based partially on the detected physical labels. The inventory system can preferably be queried to collect contextual information of an identified product such as nearby products.

User-product interaction processing modules function to detect or classify scenarios of users interacting with a product (or performing some gesture interaction in general). User-product interaction processing modules may be configured to detect particular interactions through other processing modules. For example, tracking the relative position of a user and product can be used to trigger events when a user is in proximity to a product but then starts to move away. Specialized user-product interaction processing modules may classify particular interactions such as detecting product grabbing or detecting product placement in a cart. User-product interaction detection may be used as one potential trigger for a product detection module.

A person detection and/or tracking module functions to detect people and track them through the environment.

A person identification module can be a similar module that may be used to uniquely identify a person. This can use biometric identification. Alternatively, the person identification module may use Bluetooth beaconing, computing device signature detection, computing device location tracking, and/or other techniques to facilitate the identification of a person. Identifying a person preferably enable customer history, settings, and preferences to be associated with a person. A person identification module may additionally be used in detecting an associated user record or account. In the case where a user record or account is associated or otherwise linked with an application instance or a communication endpoint (e.g., a messaging username or a phone number), then the system could communicate with the user through a personal communication channel (e.g., within an app or through text messages).

A gesture, event, or interaction detection modules function to detect various scenarios involving a customer. One preferred type of interaction detection could be a customer attention tracking module that functions to detect and interpret customer attention. This is preferably used to detect if, and optionally where, a customer directs attention. This can be used to detect if a customer glanced in the direction of a product or even if the product was specifically viewed. A location property that identifies a focus, point, or region of the interaction may be associated with a gesture or interaction. The location property is preferably 3D or shelf location “receiving” the interaction. An environment location property on the other hand may identify the position in the environment where a user or agent performed the gesture or interaction.

Alternative forms of CV-based processing modules may additionally be used such as customer sentiment analysis, clothing analysis, customer grouping detection (e.g., detecting families, couples, friends, or other groups of customers that are visiting the store as a group), and/or the like. The system may include a number of subsystems that provide higher-level analysis of the image data and/or provide other environmental information such as a real-time virtual cart system.

The real-time virtual cart system functions to model the products currently selected for purchase by a customer. The virtual cart system may enable automatic self-checkout or accelerated checkout. Product transactions could even be reduced to per-product transactions (purchases or returns based on the selection or de-selection of a product for purchase).

In some variations, the system can include a digital management platform, which functions to enable store operators, product manufacturers, or other entities to set configuration, review reports, and/or otherwise interact with the system. The digital management platform may include an administrative console or portal that is a user interface (e.g., a graphical user interface) operable on a computing device. In some variations, one or a set of products can be selected. Presentation preferences could be set within the digital management platform and then those preferences could be used in enforcing or automating stocking activities through the system. For example, a first product identifier could be selected and set for a first stacked arrangement, and a second product identifier could be selected and set for a front facing side-by-side arrangement. These targeted presentation preferences could then be used by the system to detect if and how products match the targeted presentation and direct stocking activities when they significantly deviate from the targeted format.

### 3. Method

A method for automated management of product presentation functions to integrate detected presentation properties into various system integrations. Method variations can enable various functionality such as generation of presentation characterizations, automated creation of classification deep learning models, and/or application of presentation characterizations. Method variations can apply the method to interpret product presentation using various events of interest like purchases or product interactions to aid in normalizing impact of presentation.

The methods are preferably implemented by a system such as the one described above but may alternatively be implemented through any suitable type of system. The method can include a variety of variations, as described herein, which may be used independently or in combination.

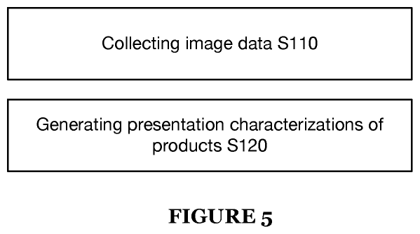

A first set of method variations for automated management of product presentation can include variations directed at using automated remote sensing of an environment to generate updated presentation characterizations of products in the environment. As shown in FIG. 5, this may include collecting image data S110 and generating presentation characterizations of products S120. More specifically, this includes collecting image data of products displayed within an environment (S110) and generating, using image processing of the image data, presentation characterizations of products in the environment (S120). This variation preferably uses computer vision processing of the image data to transform visual data into data characterization related to the presentation of the detected products. As described herein, different variations may have an outputted presentation characterization be a score, set of scores, classification, description and/or other form of data characterization related state of presentation.

In some variations, variations for generating a presentation characterization can be configured to provide product-level presentation characterization information. Accordingly, in some variations, the method can include collecting image data S110, determining product presentation image data of detected products in the image data S112, generating presentation characterizations of detected products using the product presentation image data (S120). In this variation, products can be detected and associated with a product identifier and then product-specific presentation characterization can be generated.

This can be performed repeatedly, and across a plurality of products. As such, through repeated instances of this method process, the method may be configured for characterizing presentation properties for a set of products in the environment. In this way, the method may be performed iteratively/repeatedly for a set of products such that another method variation can include collecting image data of a set of products in an environment S110, determining product presentation image data of the set of products in the image data (S112), for each product of the set of products, generating presentation characterization of each product using the product presentation image data of each product (S120).

The generating of a presentation characterization may use a presentation classification model and/or use one or more process for otherwise extracting presentation properties used in forming the presentation characterization.

In some alternative variations, variations of generating a presentation characterization can be configured to provide generalized presentation characterization information. The subprocess of characterizing of presentation properties may be performed over a collection of products or for a subregion of the environment. For example, presentation characterization may generate a measure of presentation for a subregion of an aisle (e.g., one region of a shelf in an aisle) in a grocery store. This may be done with or without determination of product identity.

Presentation characterizations may be used in a variety of ways. As a first exemplary application, presentation characterizations enable an active and reactive output signal concerning the presentation state of one or more product, which results from a unique and specially configured monitoring system. In some variations, characterizing presentation properties of detected products can be used with collecting product purchase event data and then generating presentation purchase analysis.

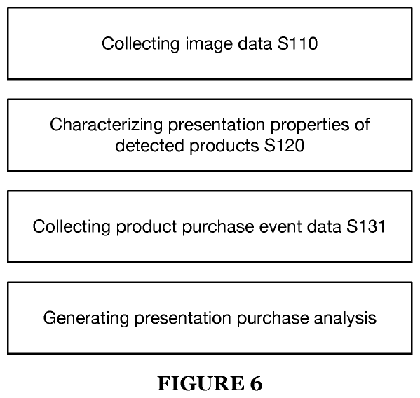

In one variation shown in FIG. 6, the method can include collecting image data S110, characterizing presentation properties of detected products S120, collecting product purchase event data S131, and generating presentation purchase analysis.

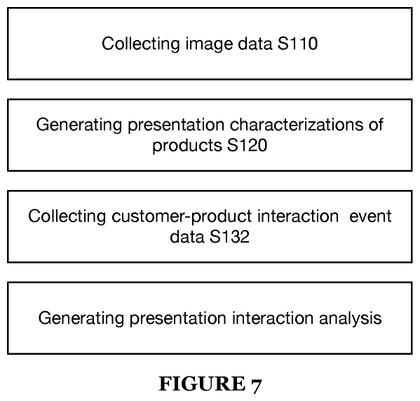

In another variation shown in FIG. 7, the method can include collecting image data S110, characterizing presentation properties of detected products S120, collecting customer-product interaction event data S132, and generating presentation interaction analysis.

Other variations may use the method in automating communication and control of various systems, in particular operational systems. These variations may include selecting products within the retail environment prioritized by presentation properties and/or presentation purchase analysis and directing an operational system based on selected products.

Another set of method variations for automated management of product presentation may include variations that use detected presentation characterization(s) in updating state of a connected device. Such variations may be used in automating communication and control of various systems, in particular operational systems. This may be used in updating a report output or within a user interface of a computing device. This may alternatively be used in updating state of an operational device or system to facilitate performance of various operational tasks (restocking products and/or “facing” of products). These variations may include selecting products within the retail environment prioritized by presentation properties and/or presentation purchase analysis and directing an operational system based on selected products.

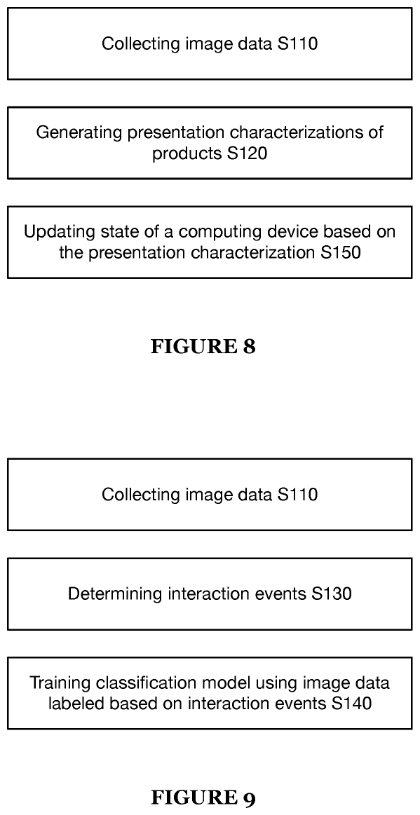

Accordingly, as shown in FIG. 8, some method variations may include: collecting image data S110 and generating presentation characterizations of products S120 (or some variation of generating a presentation characterization) and updating state of a computing device based on the presentation characterization S150.

Another set of method variations for automated management of product presentation may include variations for generating one or more learning models (e.g., a classification neural network) based on product presentation and interactions. In such variations, a presentation classification model may be trained based on, for example, user interactions (e.g., product inspection, product pickups, product put-backs, etc.) and/or product purchase data. Accordingly, a variation of the method used at least in part for generating a presentation classification model, as shown in FIG. 9, can include collecting image data S110, determining interaction events S130, training classification model using image data labeled based on interaction events S140.

Interaction events could include collected checkout event data such as a received log or data stream of transactions indicating completion of checkout/purchase of a product. Such checkout data may be provided by one or more checkout systems. Interaction events could additionally or alternatively include other forms interaction data such as user-product interactions detected through a CV monitoring system.

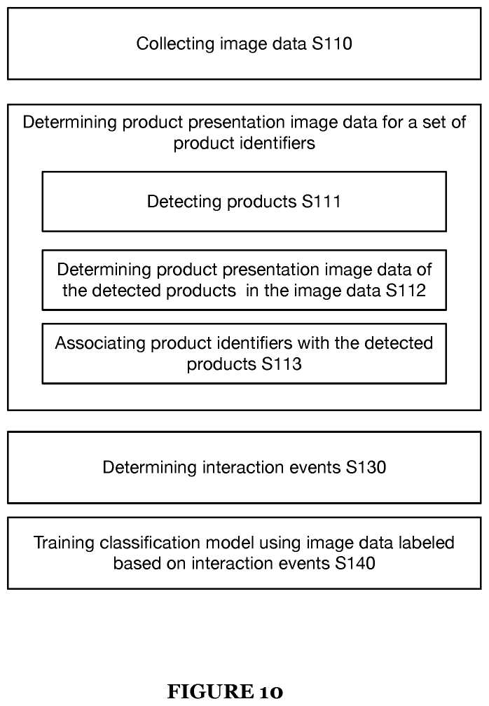

In some variations, the interaction data is correlated and mapped to presentation data and/or image data of associated products on display. Accordingly, a method variation for generating a presentation classification model may, in some variations, may include collecting image data S110; determining product presentation image data for a set of product identifiers which can include detecting products S111, determining product presentation image data of the detected products in the image data S112, associating product identifiers with the detected products S113; determining interaction events, with each interaction event associated with at least one product identifier S130; and training classification model using product presentation image data for different product identifiers labeled based on interaction events S140, as shown in FIG. 10.

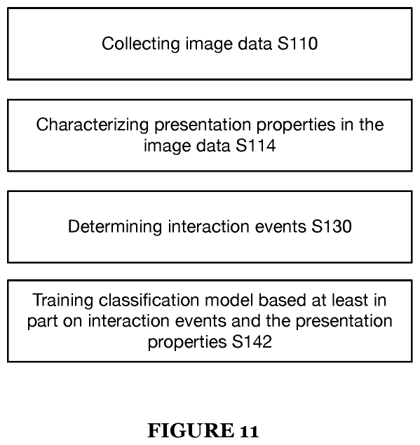

In some variations, alternative or additional input features may be used when training the classification model. The additional input features could be parameters determined from the image data or other sources that relate to the presentation of one or more products. Accordingly, some variations of the method, as shown in FIG. 11, may include: collecting image data S110; characterizing presentation properties in the image data S114; determining interaction events S130; and training classification model based at least in part on interaction events and the presentation properties S142. The presentation properties can be supplemental or intermediary image or product analysis results The presentation properties may be input features derived by determining placement properties (e.g., store location, shelf location, etc.), determining arrangement properties (e.g., classification, metrics, or descriptions of how the product is stocked), determining adjacent items properties, determining adjacent or proximal marketing material, determining product packaging variations, classifying product, and/or other properties related to presentation of one or more product in a store.

In a variation where presentation properties are used in combination with presentation image data, a method variation may include collecting image data S110; determining product presentation image data for a set of product identifiers; characterizing presentation properties in the image data for the set of product identifiers (S114); determining interaction events, with each interaction event associated with at least one product identifier (S130); and training classification model using product presentation image data and presentation properties for different product identifiers labeled based on interaction events (S140/S142).

In some variations, the generation of a presentation classification model is used in combination with use of the presentation classification model. In such variations, collected image data may be used for different operations. Accordingly, variations of the method may include, for example, collecting a first set of image data within an environment of monitored products during a first time period (S110); determining product presentation image data for a set of product identifiers from the first set of image data; determining interaction events associated with the set of product identifiers (S130); training a presentation classification neural network using the first set of image data labeled based on the interaction events (S140); collecting a second set of image data during a second time period (S110); optionally determining product presentation image data for a set of product identifiers from the second set of image data; and generating a presentation characterization of a product by processing the second set of image data using the presentation classification neural network (S120).

Block S110, which includes collecting image data functions to collect video, pictures, or other imagery of products displayed within an environment. The image data is preferably captured over a region expected to contain objects of interest (e.g., inventory items) and interactions with such objects. Image data is preferably collected from across the environment from a set of multiple imaging devices. Preferably, collecting image data occurs from a variety of capture points. The set of capture points include overlapping and/or non-overlapping views of monitored regions in an environment. Alternatively, the method may utilize a single imaging device, where the imaging device has sufficient view of the exercise station(s). The image data preferably substantially covers a continuous region. However, the method can accommodate for holes, gaps, or uninspected regions. In particular, the method may be robust for handling areas with an absence of image-based surveillance such as bathrooms, hallways, and the like.

The image data may be directly collected and may be communicated to an appropriate processing system. The image data may be of a single format, but the image data may alternatively include a set of different image data formats. The image data can include high resolution video, low resolution video, photographs from distinct points in time, image data from a fixed point of view, image data from an actuating camera, visual spectrum image data, infrared image data, 3D depth sensing image data, parallax, lidar, radar, sonar, passive illumination, active illumination, and/or any suitable type of image data.

The image data preferably captures products in their displayed state. For example, the image data can include multiple video/image feeds from different cameras of products on shelves, bins, and/or other product displays.

The method may be used with a variety of imaging systems, collecting image data may additionally include collecting image data from a set of imaging devices set in at least one of a set of configurations. The imaging device configurations can include: aerial capture configuration, shelf-directed capture configuration, movable configuration, and/or other types of imaging device configurations. Imaging devices mounted over-head are preferably in an aerial capture configuration and are preferably used as a main image data source. In some variations, particular sections of the store may have one or more dedicated imaging devices directed at a particular region or product so as to deliver content specifically for interactions in that region. In some variations, imaging devices may include worn imaging devices such as a smart eyewear imaging device. This alternative movable configuration can be similarly used to extract information of the individual wearing the imaging device or other observed in the collected image data.

Collected image data may be used in generating and training classification model(s) and/or used in assessing and monitoring state of presentation of one or more products. Accordingly, image data can be collected continuously or periodically during windows of time and/or over different time windows of interest.

The image data may be collected for generation/training of a presentation classification model. The image data may additionally or alternatively be collected for monitoring of presentation state. In some instances, the image data may additionally be processed and used for additional processes such as for CV-facilitated checkout processing or inventory management.

In some variations, the image data may be assessed and analyzed without explicitly mapping presentation to specific product identifiers. In some variations, however, the method can include determining product presentation image data for a set of product identifiers, which functions to associated portions of image data with particular products that are identified by some product identifier. A product identifier could be a SKU identifier or any suitable identifier of an item. Determining product presentation image data for a set of product identifiers can include detecting products S111, determining product presentation image data of the detected products in the image data S112, associating product identifiers with the detected products S113.

Block S111, which includes detecting products, functions to identify products in the image data. Detecting products is preferably performed by processing imaged data using one or more object detection model such as using a trained product classification neural network. This can include processing images from each image/video stream of each camera generating the image data and identifying. Detecting products may additionally or alternatively use other data sources such as using a provided or generated planogram or product map so that product identity can be extracted or predicted based at least in part on such a product map. A product map can use general product location information but may alternatively map products to specific storage/display locations in a store.

Block S112, which includes determining product presentation image data of detected products in the image data, functions to associate subsections of the image data with particular products. Product presentation image data is used to characterize portions of image data specifically related to presentation of one or more product. In some variations, the product presentation image data would be image data cropped or selected as the bounding box (or bounding outline) around all instances of products displayed as a group. One product identifier may have multiple instances of product presentation image data if the product is not displayed as a singular group (e.g., if it is split up into different regions).

Determining product presentation image data may alternatively be described as segmenting image data into image subregions associated with each of a set of product identifiers. In the example of image data of a shelf, each product type on the shelf can have image data extracted that includes the regions where that particular product is stocked. Determining product presentation image data may be performed as a separate image segmentation operation separate from detecting products but may alternatively be part of the same or integrated process for segmenting image data by product identifiers. As with detecting products, determining product presentation image data may use CV image processing by may additionally or alternatively use a product map or other data sources to facilitate segmenting image data. For example, a planogram of product placement on shelves in an environment may be used in automating segmentation of image data.

Block S113, which includes associating product identifiers with the detected products, functions to map selections of product presentation image data with associated product identifiers. Associating a product identifier with a select set of product presentation image data can enable the image data of that product at different times to be individually monitored. This monitoring may be used to correlate presentation of a product with a detected interaction. This may be used in training a presentation classification model. Alternatively, this may be used in analyzing how different presentation states correspond to different interactions.

Block S114, which includes characterizing presentation properties in the image data functions to extract some presentation properties from the image data. In the variations described herein, the presentation properties may be intermediary characterizations of presentation that may form part of the presentation characterization or used in facilitating the generation of a presentation characterization. In one particular application, the presentation properties may be used as input features used in training a presentation classification model and then later used in supplying input data to generate a resulting assessment of presentation using the presentation classification model. Presentation properties may additionally or alternatively be used in generating a presentation characterization.

Characterizing presentation properties may include determining placement properties (e.g., store location, shelf location, etc.), arrangement properties (e.g., classification, metrics, or descriptions of how the product is stocked), determining adjacent items properties, determining adjacent or proximal marketing material, determining product packaging variations, classifying a product, assessing inventory amount, and/or other processes.

Determining placement properties functions to provide placement and/or location parameters for one or more products. In one variation, this may include the location within the environment. In another variation, this may include the location on a particular shelf, bin, or aisle.

Determining arrangement properties may be used to provide some parameters or properties that relate to how a product is arranged. These can include basic assessments such as general classification in the type of stocking (e.g., stacked, edged facing, front facing, etc.). This may use a classification neural network model or other suitable CV classification process. Arrangement properties could additionally or alternatively include parameters like amount of linear shelf space or other measure of shelf space used by a displayed product.

Determining adjacent items properties functions to identify and track the products directly adjacent to a particular product or in proximity to a product (e.g., within some physical distance threshold or stocking distance threshold). Adjacent items properties can enable presentation to consider how proximity to other products impacts the effective “presentation” of products. As discussed, this may be measured by analyzing and/or modeling how “presentation” of products alters interaction performance.

Determining adjacent or proximal marketing material functions to identify and track advertisements or other promotional material in proximity to a product. As with adjacent products, marketing materials can impact the “presentation” of a product. Determining adjacent or proximal material can include detecting marketing material directly associated with a product identifier of a particular product. This can enable the method to distinguish between marketing material for a particular product or for another product.

Determining product packaging variations functions to assign a label or classification for the type of packaging of a particular product. This may be basic classification into the type of product packaging (e.g., can, box, bag, etc.). Determining packaging variations may additionally include visually classifying packaging design variations such that different graphical designs of a product can be distinguished and assigned an identifier. In this way, the method can enable tracing impact of presentation by different packaging designs.

Classifying a product can function to perform various product characterization such as assigning a product category, determining product brand, or determining other attributes of a product.

Assessing inventory amount functions to assess or measure amount of inventory. This may be performed by using CV analysis of the image data to generate a predicted count of product items. Alternatively, inventory amounts may be provided from an inventory system or any suitable system.

Block S130, which includes determining interaction events, functions to detect instances of different interactions. In particular, block S130 includes determining interaction events associated with one or more product identifiers. In other words, determining interaction events detects interaction events that involve a product. Those interactions can then be correlated back to product presentation image data through the product identifiers.

As an alternative variation, interaction events may be associated with locations within the environment and thereby associated with one or more product presentations. For example, interaction events may be tracked as to which products or regions are near the occurrence of the interaction event.

Interaction events may include any suitable type of action to which one would want to relate to product presentation. Two exemplary types of interaction events can include product purchase event data and/or user-product interaction event data.

In a product purchase event data variation, the interaction events include event data related to transaction data. Accordingly, determining interaction events can include collecting product purchase event data, which can facilitate mapping purchase information to presentation of products at or around time of a purchase. Collecting product purchase event data can include receiving product purchase event data (e.g., transaction logs, receipt logs) from a checkout system. This may be acquired in bulk or received in substantially real-time (e.g., communicated in response to generation of the data) as products are purchased through a checkout system. Some variations may include generating product purchase event data my operating the checkout system.

Purchase information may be collected from a checkout system such as the T LOG data from a POS system. The purchase information may alternatively be collected from an automated checkout system, which may use the CV monitoring system 120, and/or other monitoring systems to track a virtual cart of a customer.

Product purchase event data can include a product identifier that is used to map it to product presentation image data. The product purchase event data may additionally include a timestamp so that it may be associated with a selection of product presentation image data at or around the time of the timestamp. In general, product presentation image data is selected within a time window preceding the purchase of a product. The time window could be a preset threshold. The time window could alternatively be dynamically determined. For example, the time window for selecting product presentation image data can be determined based on the set of items in a transaction—more items can result in a longer time window. Alternative processes may be used in selecting and/or otherwise determining product presentation image data to associate with a particular interaction event.

In one variation, purchases of individual items may be mapped directly to the presentation state of that item and related items. For example, the image data may be used to detect which product instance is selected by a customer and then associate that product's purchase with the presentation properties at the point when the customer was selecting the product.

In some variations, purchase event data can be used to augment assessment of a presentation characterization. For example, a presentation characterization score can be generated that is based on the impact of presentation on purchases. This may be normalized across other products (e.g., all products, products within a product category). For example, an analysis of all cereals can be performed that shows the percentage of one cereal type of all cereal sales as it relates to presentation.

In another way, a classification model can be trained to characterize presentation based directly on purchase rates. In this way, the system can lack any explicit understanding of the intended presentation of the products and the model can be trained so as to intuit the presentation features that map to improved sales.

In a customer-product interaction variation, the interaction events can include event data related to detected user-product interactions. Accordingly, determining interaction events can include collecting user-product interaction event data (e.g., customer-product interaction event data), which functions to map detected interactions to presentation state. This may be used to understand how presentation impacts a wider variety of customer actions such as viewing products, inspecting products, selecting a product instance from a product section (e.g., does a customer dig through several boxes before finding one), setting a product back, adding a product to a cart, and the like. Collecting user-product interaction event data may be received from an outside system used in monitoring and tracking user interactions. Alternatively, the method may include detecting user-product interactions. Detecting the user-product interactions may be performed by processing the image data. CV image/video classification models may be used in detecting various actions. Detected user interaction events preferably indicate their location, time of the event, and possibly one or more product identifier associated with the interaction. This can enable user-product interactions to be mapped to product presentation image data associated with the product identifier of a particular user-product interaction.

As with the purchase event data, user-product interaction event data can be used to augment assessment of a presentation characterization and/or to train a presentation classification model.

Block S140, which includes training classification model using image data labeled based on interaction events, functions to generate a classification model that correlates presentation of a product with various types of interactions of interest. The classifier is preferably a presentation classification model as described herein. The interactions of interest may include desired interactions such as purchase or receiving attention. The interactions of interest may alternatively include interactions that are not desired such as rummaging through products. Training a presentation classification model can include generating a new presentation classification model and/or updating a presentation classification model.

Labeling of data may label data directly associated with some interaction event. Labeling of data may additionally or alternatively use interaction data to generate a suitable label. For example, interaction event data can be converted to an interaction frequency rate such that presentation image data not associated with an interaction event may still be used as input data. Additionally, interaction data may be normalized or otherwise calibrated across the set of products or a set of related products. For example, the transaction data for cereal could be normalized across all cereals so that frequency of purchases for cereals is calibrated in a manner specific to the type of products. This in turn may enable a more reliable assessment of the impact of presentation of any particular type of cereal.

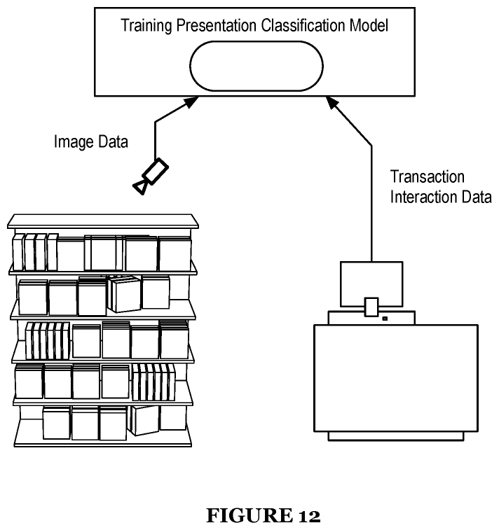

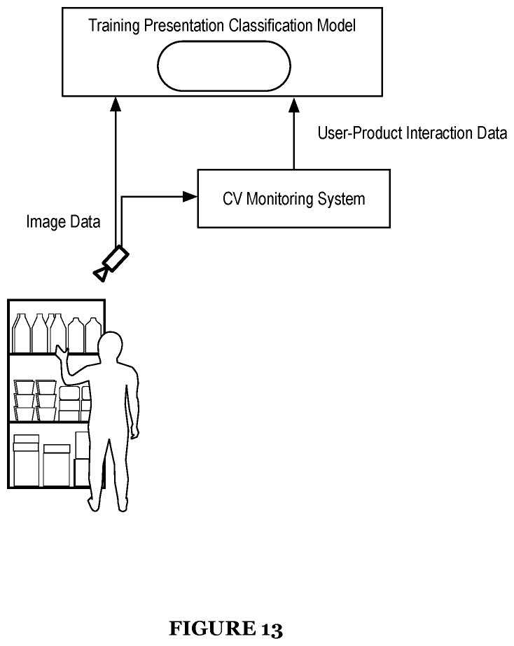

Training the classification model can use supervised learning in using a training data set that is generated and collected using an automated process as described above. Training the classification model can include training the classification model using, image data and/or presentation properties as input data labeled by associated interaction events. In one variation, the image data (or feature inputs derived from the image data) can be labeled based on associated interaction events. As shown in FIG. 12, transaction interaction event data may be used in combination with image data in training the classification. As shown in FIG. 13, detected user-product interaction event data may be used in combination with image data in training the classification. These variations can function so that an image classification model can be trained to automatically detect types of presentations that are predicted to result in different interaction event. This can make the method flexible in its use, because store operators are not limited to only performing rigid types of presentation.

In another variation, training a presentation classification model using interaction labeled training data can include other presentation properties as feature inputs such as other CV characterizations of products, location data, marketing materials, and/or other inputs.

A resulting presentation classification model may be used in assessing presentation. When supplied appropriate feature inputs an output can be generated that provides the presentation characterization.

Block S120, which includes generating presentation characterizations of products, functions to score or otherwise generate a descriptor of the presentation of one or more products in an environment. In some variations, the presentation characterization can include one or more metric related to the presentation of the product.

The presentation characterization of a product preferably relates to how a product is presented when displayed in a retail environment. In some variations, the presentation characterization may relate to the “tidiness” of a product. This may be visible tidiness properties automatically generated through image analysis where the properties are related to conforming to a desired and orderly presentation. The presentation characterization may alternatively be some classification, or score related to an assessment of how its presentation predicts resulting interactions. In some variations, the presentation characterization may relate to the product presentation being at or deviating from some desirable presentation state.

In some cases, the presentation characterization may additionally include detected properties of the actual product such as the branding or product packaging.

Generating presentation characterizations can include generating the presentation characterization using product presentation image data. In this way, product presentation image data can be supplied as input. Other inputs such as presentation properties described above may additionally or alternatively be used as inputs.

Generating presentation characterizations of products may analyze individual product instances but may additionally analyze product sections in the store. For example, the presentation of a variety of breakfast cereal may have a presentation score assigned to it in place of or in addition to individual presentation scores.

Generating presentation characterizations of the detected products preferably includes detecting a product instance in the image data, selecting image data of the product instance, and analyzing the image data through one or more image processing routines.

Detecting products instances or product sections may use CV object detection. Detecting products may additionally or alternatively use product mapping to understand the general product positioning within the store. For example, transaction event data and/or stocking event data may be mapped to product changes on shelf, from which an automated planogram is generated.

The presentation characterization may include a single presentation score, which could be a numerical metric of its presentation. One value of the presentation score can be associated with ideal or suitable presentation and changes in the value in one or more directions can indicate the degree of divergence from ideal presentation.

In some cases, a presentation score can be an artificial score using multiple factors. In other cases, the presentation score may be directly tied to an aspect of the presentation such as the angular measurement of alignment with the front of a shelf.

A product-section related presentation characterization may include collective measurement of the orderliness of the individual products, the arrangement of the products, and/or other factors.

In some cases, the presentation characterizations can be a classification into at least two categories. These categories may characterize different states or conditions. In some cases, the classifications can be applied as tags or labels where a product instance may have multiple presentation labels at any one time. Classifications and labels may include descriptors such as “orderly presentation”, “front facing arrangement”, “side facing arrangement”, “unaligned facing”, “unorganized presentation”, “damaged goods”, “tipped over goods”, and/or other suitable classifications/labels.

In one variation, CV analysis of the products may model the geometric orientation of the product packaging and relate that to the orientation of the shelving.

In one variation, characterizing the presentation of the products may be achieved by comparing the current presentation to the human-set presentation. In one variation, this may be performed by coordinating with stocking events, which can include detecting a stocking event and detecting the presentation of the product associated with the stocking event. This can include saving product presentation image data associated with the stocking of the product. This functions to detect the intended presentation of a product. The image data associated with the stocking event and/or CV characterization of the product can be set within a data system as the benchmark. Later, the image data of the product can be compared to this presentation benchmark.

Various CV analysis approaches may be used which may include using a deep learning neural net or other suitable form of machine learning or AI model for classifying one or more presentation properties. In some variations, the presentation classification model generated as described herein may be used in generating a presentation characterization. In such a variation, the output of the classification model can relate to the interaction event(s) used in generating the classification model.

In some variations, product presentation image data and/or other presentation properties can be processed by a plurality of classification models trained for different interactions. This may be used, for example, to assess how current presentation can impact purchases, user attention, and/or user rummaging through the products.

Block S150, which includes updating state of a computing device based on the presentation characterization, functions to use the presentation characterization to alter operation of one or more devices. In some variations, this may include updating a user interface of a computing device for reporting state or analysis of the presentation characterization of one or more products. In other variations, updating state of a computing device may enable automating communication and control of various systems, in particular operational systems used for managing inventory and/or worker tasks. These variations may include selecting products within the retail environment prioritized by presentation properties and/or presentation purchase analysis and directing an operational system based on selected products. Examples of operational systems could include a worker mobile device (configured with an application or other service to integrate with the system) and/or robotic systems used to perform stocking actions.

In variations including updating a user interface of a computing device, the method can include generating a report based on one or more presentation characterizations. In some instances, the presentation characterizations of a set of products can be tracked and analyzed. The method can include detecting a state of the presentation characterization satisfying a condition for a stocking task. This can include comparing presentation characterizations to prioritize products by quality of presentation, which may be used in determining relative priority for stocking activities such as restocking, facing of products (e.g., resetting arrangement), reconfiguring of products and/or other actions.

In one variation, updating a user interface can include updating user interface in an administrative console with the presentation characterization of at least one product. This can enable a user interface to change based on detected state of presentation. The administrative console may enable navigation and queries to perform for selection of products for inspection. Similarly, the administrative console can enable different filters to be implied. Furthermore, the method can include analyzing presentation characterizations of products compared to different related metrics such as time, interactions, location, related products and/or other properties.

In one variation, the method can include generating a map of presentation characterizations of a set of products that associates location of different products and presentation characterization. The map of presentation characterization may be displayed within a user interface. In one exemplary implementation, a map of an environment could be presented as a heat map of state of presentation characterization. The color/shading of the map can vary with quality of presentation as indicated by the presentation characterizations. For example, messy regions of the store could be highlighted in red, slightly untidy areas are yellow, and well-organized areas may show as green. While the current presentation characterization may be used directly, in some variations the change in presentation characterization may also be of interest and so the change in presentation characterization can be used in generating the map or other presentation-related reports. Additionally or alternatively, a map of presentation characterization may be used in generating and communicating stocking tasks to worker devices and/or robotic devices.

In many uses of the presentation characterization, especially those for operators of a store, the relative state of presentation is of interest. Reporting and control of devices may be based on relative state of presentation characterizations. These variations can include selecting and/or prioritizing products within the retail environment prioritized by presentation, presentation purchase analysis, and/or presentation interaction analysis; and directing an operational system based on the selected/prioritized products. This is preferably used to detect when products or regions of the store can benefit from changes to presentation. For example, the method can be used to detect when cereal on display may need to be rearranged. This selection process can analyze the whole retail environment and prioritize where changes will have the most impact. It may additionally determine locations or regions where there are multiple products or product sections that can be improved such that product facing can be localized within one region of the store, thereby having a larger impact compared to other changes.

In variations used for managing or directing stocking activities, updating the state of a computing device based on the presentation characterization can include detecting a state of the presentation characterization satisfying a condition for a stocking task and initiating communication to one or more computing device based on the stocking task. This can be applied to creating automated assignment of stocking activities for a worker. This may alternatively be used in automating activities of a robotic stocking devices.

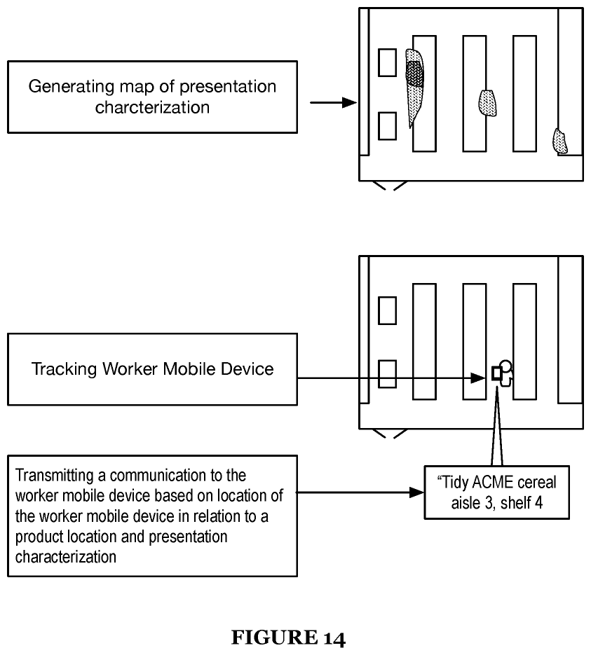

For a worker, the tasks may be added and optionally prioritized within a worker tool. In some variations, the method can include detecting resolution of the stocking task as described herein, such that the set of tasks is dynamically updated and maintained. In another variation, stocking tasks may be automatically delivered based on state of the presentation characterization, location of the associated product, and location of the worker (e.g., worker computing device) and delivering tasks in manner responsive to the conditions of the environment. Accordingly, the method may include detecting or tracking worker location and activity as well as customer location and activity. This can be used to intelligently determine when to initiate presentation stocking tasks and to which worker they should be directed. For example, a product facing task may be assigned to one worker that is currently assigned a lower priority task, that is in proximity to the location of the product(s), and when the task would not disrupt the shopping of customers. Such a variation may make use of the map of presentation characterizations described above and include tracking location of a worker mobile device and transmitting a communication to the worker mobile device based on location of the worker mobile device in relation to a product as shown in FIG. 14.

While described for a worker mobile device, similar actions could similarly be applied to a robotic stocking device. This may be used where one or more mobile robotic stocking device is provided and capable of performing some or all stocking tasks such as setting arrangement of products, stocking products, moving products, and the like.

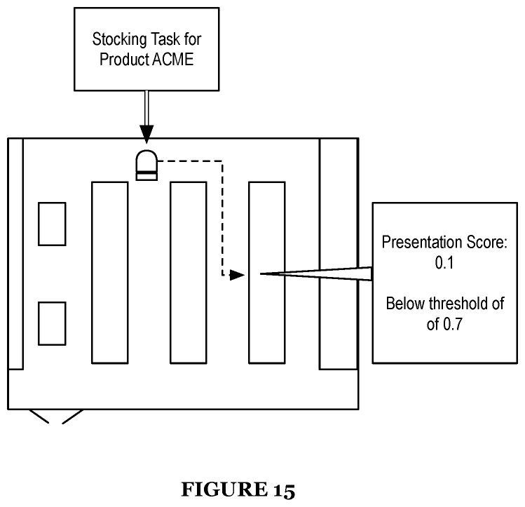

A mobile robotic stocking can be controlled to move to different areas of a store and directed on which products to perform facing/arrangement correction. In some variations, the method may coordinate the control of such an automated item stocking system such that it operates as a substantially background activity that can have minimal impact on customers and/or workers. The robotic stocking device may be automatically controlled to address presentation issues in a way that can be prioritized by the degree of urgency as indicated through the presentation characterization and performed around human workers and customers to avoid interfering with their activities. Accordingly, variations of the method can include detecting a state of the presentation characterization satisfying a condition for a stocking task; and then updating state of the computing device based on the presentation characterization by directing a mobile stocking robot to perform a stocking task of the product based on the state of the presentation characterization. As shown in the example shown in FIG. 15, a robot may be alerted and controlled to adjust the display of a product when the presentation characterization has a score below some threshold (e.g., a 0.1 score indicating a product is not in a target presentation state).

The method may additionally include detecting resolution of a stocking task by detecting change in presentation characterization. In one implementation, a worker or robotic system may indicate completion of a stocking task, the method can include updating the presentation characterization for the one or more products associated with the stocking task and updating the stocking task based on the updated presentation characterization. If successfully complete the presentation characterization will generally change to be in compliance with a desired state (e.g., displayed properly). If unsuccessfully completed the presentation characterization may still be in a state in condition for further action. An error message or update can be communicated back to the worker or robotic device to address the issue.

### 4. System Architecture

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

In one variation, a system comprising of one or more computer-readable mediums (e.g., non-transitory computer-readable mediums) storing instructions that, when executed by the one or more computer processors, cause a computing platform to perform operations comprising those of the system or method described herein such as: collecting image data, generating interaction data, training a presentation classification model, generating a presentation characterization, updating state of a computing device based on the presentation characterization, and/or other processes or variations described herein

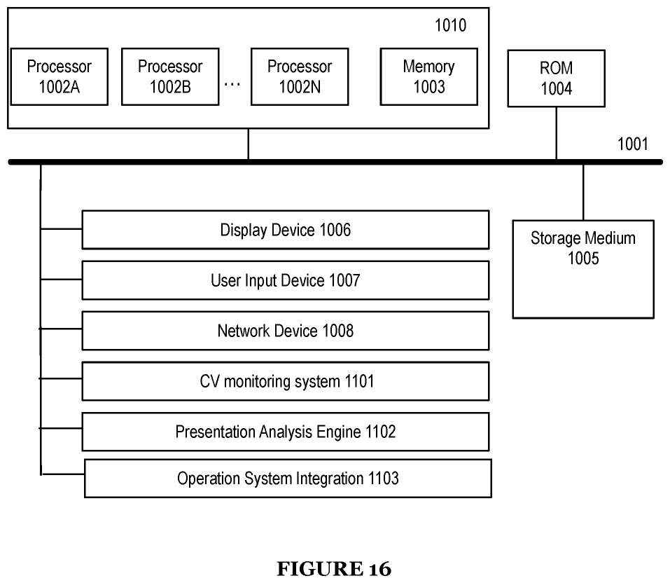

FIG. 16 is an exemplary computer architecture diagram of one implementation of the system. In some implementations, the system is implemented in a plurality of devices in communication over a communication channel and/or network. In some implementations, the elements of the system are implemented in separate computing devices. In some implementations, two or more of the system elements are implemented in same devices. The system and portions of the system may be integrated into a computing device or system that can serve as or within the system.

The communication channel 1001 interfaces with the processors 1002A-1002N, the memory (e.g., a random-access memory (RAM)) 1003, a read only memory (ROM) 1004, a processor-readable storage medium 1005, a display device 1006, a user input device 1007, and a network device 1008. As shown, the computer infrastructure may be used in connecting a CV monitoring system 1101, presentation analysis engine 1102, operation system integration 1103, and/or other suitable computing devices.

The processors 1002A-1002N may take many forms, such CPUs (Central Processing Units), GPUs (Graphical Processing Units), microprocessors, ML/DL (Machine Learning/Deep Learning) processing units such as a Tensor Processing Unit, FPGA (Field Programmable Gate Arrays, custom processors, and/or any suitable type of processor.

The processors 1002A-1002N and the main memory 1003 (or some sub-combination) can form a processing unit 1010. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of the elements of the system.

A network device 1008 may provide one or more wired or wireless interfaces for exchanging data and commands between the system and/or other devices, such as devices of external systems. Such wired and wireless interfaces include, for example, a universal serial bus (USB) interface, Bluetooth interface, Wi-Fi interface, Ethernet interface, near field communication (NFC) interface, and the like.

Computer and/or Machine-readable executable instructions comprising of configuration for software programs (such as an operating system, application programs, and device drivers) can be stored in the memory 1003 from the processor-readable storage medium 1005, the ROM 1004 or any other data storage system.

When executed by one or more computer processors, the respective machine-executable instructions may be accessed by at least one of processors 1002A-1002N (of a processing unit 1010) via the communication channel 1001, and then executed by at least one of processors 1001A-1001N. Data, databases, data records or other stored forms data created or used by the software programs can also be stored in the memory 1003, and such data is accessed by at least one of processors 1002A-1002N during execution of the machine-executable instructions of the software programs.

The processor-readable storage medium 1005 is one of (or a combination of two or more of) a hard drive, a flash drive, a DVD, a CD, an optical disk, a floppy disk, a flash storage, a solid-state drive, a ROM, an EEPROM, an electronic circuit, a semiconductor memory device, and the like. The processor-readable storage medium 1005 can include an operating system, software programs, device drivers, and/or other suitable sub-systems or software.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

We claim:

1. A method for automating interpretation of product presentation state comprising:
collecting a first set of image data within an environment of monitored products during a first time period;
determining product presentation image data for a set of product identifiers from the first set of image data;
determining interaction events associated with the set of product identifiers;
training a presentation classification neural network using the first set of image data labeled based on the interaction events;
collecting a second set of image data during a second time period; and
generating a presentation characterization of a product by processing the second set of image data using the presentation classification neural network.

2. The method of claim 1, further comprising updating state of a computing device based on the presentation characterization.

3. The method of claim 2, further comprising detecting a state of the presentation characterization satisfying a condition for a stocking task; and wherein updating state of the computing device based on the presentation characterization comprises directing a mobile stocking robot to perform a stocking task of the product based on the state of the presentation characterization.

4. The method of claim 2, further comprising generating a map of presentation characterizations of a set of products that associates location of different products and presentation characterization.

5. The method of claim 4, further comprising tracking location of a worker mobile device, and transmitting a communication to the worker mobile device based on location of the worker mobile device in relation to a product.

6. The method of claim 2, wherein updating state of the computing device based on the presentation characterization comprises updating user interface in an administrative console with the presentation characterization of at least one product.

7. The method of claim 1, wherein determining interaction events associated with the set of product identifiers comprises detecting user-product interactions, each user-product interaction associated with at least one product identifier.

8. The method of claim 7, wherein detecting user-product interactions comprises detecting user attention directed at a product associated with a product identifier.

9. The method of claim 7, wherein detecting user-product interactions comprises detecting user picking up a displayed product associated with a product identifier.

10. The method of claim 1, wherein determining interaction events associated with the set of product identifiers comprises collecting product purchase event data from a checkout system.

11. A non-transitory computer-readable medium storing instructions that, when executed by one or more computer processors of a computing platform, cause the computing platform to perform operations including:
collecting a first set of image data within an environment of monitored products during a first time period;
determining product presentation image data for a set of product identifiers from the first set of image data;
determining interaction events associated with the set of product identifiers;
training a presentation classification neural network using the first set of image data labeled based on the interaction events;
collecting a second set of image data during a second time period; and
generating a presentation characterization of a product by processing the second set of image data using the presentation classification neural network.

12. The non-transitory computer-readable medium of claim 11, further comprising detecting a state of the presentation characterization satisfying a condition for a stocking task; and directing a mobile stocking robot to perform a stocking task of the product based on the state of the presentation characterization.

13. The non-transitory computer-readable medium of claim 11, further comprising detecting a state of the presentation characterization satisfying a condition for a stocking task; tracking location of a worker mobile device; and transmitting a communication to the worker mobile device based on location of the worker mobile device in relation to a product and the state of the presentation characterization.

14. The non-transitory computer-readable medium of claim 11, wherein determining interaction events associated with the set of product identifiers comprises detecting user-product interactions, each user-product interaction associated with at least one product identifier.

15. The non-transitory computer-readable medium of claim 11, wherein determining interaction events associated with the set of product identifiers comprises collecting product purchase event data from a checkout system.

16. A system comprising of:
one or more computer-readable mediums storing instructions that, when executed by the one or more computer processors, cause a computing platform to perform operations comprising:
collecting a first set of image data within an environment of monitored products during a first time period,
determining product presentation image data for a set of product identifiers from the first set of image data,
determining interaction events associated with the set of product identifiers;
training a presentation classification neural network using the first set of image data labeled based on the interaction events,
collecting a second set of image data during a second time period, and
generating a presentation characterization of a product by processing the second set of image data using the presentation classification neural network.

17. The system of claim 16, further comprising detecting a state of the presentation characterization satisfying a condition for a stocking task; and directing a mobile stocking robot to perform a stocking task of the product based on the state of the presentation characterization.

18. The system of claim 16, further comprising detecting a state of the presentation characterization satisfying a condition for a stocking task; tracking location of a worker mobile device, and transmitting a communication to the worker mobile device based on location of the worker mobile device in relation to a product and the state of the presentation characterization.

19. The system of claim 16, wherein determining interaction events associated with the set of product identifiers comprises detecting user-product interactions, each user-product interaction associated with at least one product identifier.

20. The system of claim 16, wherein determining interaction events associated with the set of product identifiers comprises collecting product purchase event data from a checkout system.
